(19) United States
(12) Patent Application Publication
(10) Pub. No.: US 2008/0018438 A1
(43) Pub. Date: Jan. 24, 2008

(54) DOOR MONITORING SYSTEM FOR TRAILER DOOR

(76) Inventors: Rodney P. Ehrlich, Monticello, IN (US); Paul D. Nelson, Martinsville, IN (US)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 11/677,107

(22) Filed: Feb. 21, 2007

Related U.S. Application Data
(60) Provisional application No. 60/777,967, filed on Mar. 1, 2006.

(51) Int. Cl. G08B 21/00

(52) U.S. Cl. 340/431; 340/545.1

(57) ABSTRACT

A trailer includes a frame formed of metal and a door seated within the frame. The door is capable of opening and closing relative to the frame. A system is provided for use on the trailer and includes a sensor mounted on the door and a data concentrator. The sensor includes a sensing element, a transceiver and a microcontroller connected to the transceiver. The sensing element is connected to the microcontroller. The microcontroller is configured to receive information from the sensor and use the transceiver to wirelessly transmit information regarding the status of the door. The data concentrator includes a transceiver and a processor connected to the transceiver. The data concentrator is configured to wirelessly receive information regarding the status of the door from the sensor. The sensor is capable of sensing the metal material of the frame for use in determining information as to whether said door is open or closed.

### BACKGROUND

The present invention generally relates to a door status monitoring system, and more specifically relates to a wireless door status monitoring system, which can be used, for example, in a mesh network for vehicles, such as tractor-trailers.

Throughout much of the world today, the primary transportation system used to move goods from one location to another is by tractor-trailer vehicles. Such vehicles provide trucking companies, or carriers as they are known, with the capability and flexibility to transport large amounts of goods to multiple destinations efficiently.

In a typical transaction, a carrier is called upon to transport goods from one location to another by a customer, otherwise known as a shipper. Examples of shippers might include almost any manufacturer of goods. The shipper provides delivery instructions to the carrier comprising details of the shipment, including, for example, when and where to pick up the goods and where to ship them. Generally, these instructions are provided to the carrier and the carrier dispatches a vehicle to transport the goods. The instructions pertaining to the shipment are provided to vehicle operator in the form of a document commonly referred to as a “bill of lading”. The bill of lading may also provide other pertinent information concerning the shipment, such as a description and quantity of the goods being shipped.

The vehicle arrives at the shipper and is loaded with goods in accordance with the bill of lading. After the vehicle has been loaded, the vehicle operator may secure the goods by locking an access door of a trailer. In addition, a seal may be installed proximate to the door to prove that the door was not opened during transit.

When the vehicle arrives at the intended destination, commonly known as a consignee, the door is unlocked and the seal is broken, if these were used by the vehicle operator. The goods are then unloaded and received by the consignee. The consignee will generally sign the bill of lading signifying that the goods were received and also denoting the time and date of the delivery. The signed bill of lading is then generally given to the vehicle operator.

Access to the cargo onboard the vehicle is controlled by a locking mechanism proximate to a cargo door. Present locking mechanisms typically comprise a mechanical lock controlled by a combination or a key. During transit, the cargo area may be accessed at any time by simply unlocking the mechanical lock. This makes the goods susceptible to theft.

Some prior art systems sense the status of a door using a mechanical limit switch. As the door closes, the arm of the mechanical limit switch is moved to indicate that the door is closed. This type of system is believed to have been used by Trucklite, a New York based automotive lighting and electronics company.

Other prior art systems use magnetic-based switch technology to sense the status of the door. A magnetic target is mounted to the door and a reed switch is located on the sidewall where the door swings back to when fully opened. When the door is opened, the magnetic target comes into sensing range of the reed switch. The reed switch senses the magnetic target to indicate that the door is open. This type of system is believed to have been used by Vehicle Enhancement Systems (VES) and Vantage Tracking Solutions.

Another prior art system, used in 1996, used a magnet-biased reed switch, mounted in the corer of the door frame that would sense the inside, steel skin of the door when the door was closed. Yet another prior art system, used in 1999, used a magnet-biased reed switch in conjunction with a steel target plate to sense the position of the door. The reed switch was mounted to the door so that when the door was closed, the target plate would be in range of the reed switch and the door would be sensed as closed.

In the prior systems in which a secondary component apart from the sensor is needed, more parts are provided which need to be inventoried and maintained. In addition, the sensor can be installed and working, but the secondary component (for example, the target plate or the magnet target) could be removed (either through accident or on purpose), and not replaced. If this occurs, because the secondary component is missing and in the situation where the door is closed, the prior art sensing system would sense that the door is open. In the prior art system in which the sensor was mounted in the corner of the door frame and sensed the inside, steel skin of the door when the door was closed, the sensor can be knocked off when materials are being loaded into the trailer.

### DESCRIPTION OF THE PRESENT EMBODIMENT

Trailer structures are well-known. A conventional trailer is generally comprised of a body including a floor assembly, a roof assembly, a front frame to which a front wall is attached, a pair of opposite side walls and a metallic rear frame 220. A landing gear and an undercarriage attached are attached to the floor assembly by known means. The roof assembly and an upper portion of the sidewalls are secured to top rails. The floor assembly and a lower portion of the sidewalls are secured to bottom rails. The front end of the sidewalls and the front wall are connected by the front frame. The rear end of the sidewalls are connected to the rear frame 220. A rear door 222 is hingedly attached to the body by known means and seats within the rear frame 220 when the rear door is closed. The trailer may be connected to a tractor (not shown) by conventional means, such as a fifth wheel.

The rear door 222 (a pair of rear doors may be provided) is surrounded by a door seal 226 formed of a flexible material, such as vinyl. The door 222 is preferably formed from a composite plate which includes an outer skin 228 and an inner skin 230 which are bonded by a thin adhesive layer of a known flexible adhesive bonding film to a core member 232, which is sandwiched therebetween. The skins 228 and 230 are formed of aluminum or full hardened, high strength, high tension, galvanized steel. Preferably, each skin 228 and 230 is formed from galvanized steel and preferably, each outer and inner skin 228 and 230 is greater or equal to thirteen thousandths of an inch in thickness. The core member 232 may be formed from a solid plastic core or may be formed from polyurethane or a foamed thermoplastic, such as foamed high density polyethylene and, preferably made from foamed high density polyethylene (HDPE) or high density polypropylene. The core member 232 is resilient and compressible.

An embodiment of the present invention provides a door monitoring system 10 used to sense whether the door 222 of the trailer is open or is closed by sensing the absence (door 222 open) or presence (door 222 closed) of the metal of the rear frame 220 (either the corner post or the rear header). Within the system 10 is a wireless, battery powered sensor 12. The sensor 12 is configured such that it need not continually transmit information, thereby prolonging the life of its battery and the sensor 12 itself.

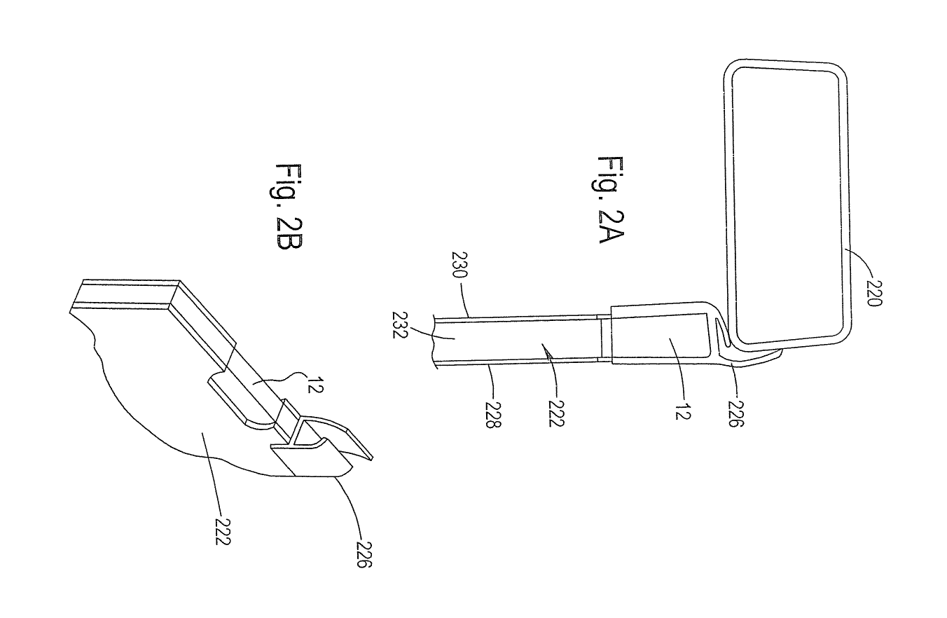

The sensor 12 is mounted on or in the door 222 of the trailer, which senses the presence or the absence of the rear frame 220. A first embodiment showing the mounting of the sensor 12 in the door 222 of the trailer is shown in FIGS. 2A and 2B. A second embodiment showing the mounting of the sensor 12 on the door 222 of the trailer is shown in FIGS. 2C and 2D.

The sensor 12 includes a sensing element 16 connected to a microcontroller or interrogator 18. The microcontroller 18 is powered by a battery 20, and is connected to a transceiver 22 which transmits and receives data using an antenna 24. The microcontroller 18 could be a Freescale HCS08 microcontroller. The sensing element 16 can be a hall effect sensor or a reed switch. The information can be sent from the microcontroller 18 using a wireless protocol, for example (but not limited to) ZIGBEE or 802.14, by the wireless transceiver 22 to a remote location. The wireless transceiver 22 can interact with other components of a network, such as object detection within the cargo area. The wireless transceiver 22 is only active, not in sleep state, based on either event, door 222 opening/closing or status requested from the location.

In the first embodiment shown in FIGS. 2A and 2B, the sensor 16 is mounted within the door 222 along an edge thereof. The metal skins 228 and 230 are cutaway in the area surrounding the sensor 12 so that the metal will not interfere with the operation of the sensing element 16 in the sensor 12. The door seal 226 can extend over at least a portion of the sensor 12 and may extend over the entire sensor (the door seal 226 is shown cutaway in FIG. 2B to show the sensor 12). Because the door seal 226 is non-conductive, the door seal 226 will not interfere with the operation of the sensing element 16 in the sensor 12. If the door seal 226 covers the sensor 12, an operator will not be able to see the presence of the sensor 12. The sensor 12 can be mounted in the door 222 by adhesive, fasteners or other suitable means. In this embodiment, because the sensor 12 is mounted within the door 222, cargo space within the trailer is not used. In addition, the risk of the sensor 12 being accidentally hit by an outside element is minimal such that the sensor 12 will not be easily dislodged from engagement with the door 222.

As an alternative, the door does not need to be formed of a composite plate, and instead can be formed of a solid material. In this situation, the material surrounding the sensor is replaced with a non-metallic material so that any metal in the door will not interfere with the operation of the sensing element in the sensor.

In the second embodiment shown in FIGS. 2C and 2D, the sensor 12 is mounted on the interior surface of the door 222 proximate to an edge thereof. As shown, the door seal 226 extends between an upper portion of the sensor 12 and the composite plate member 224 (the door seal 226 is shown cutaway in FIG. 2D for ease in illustration). Because the door seal 226 is non-conductive, the door seal 226 will not interfere with the operation of the sensing element 16 in the sensor 12. A lower portion of the sensor 12 sits against the inner skin 230 of the door 222 and is mounted thereto by adhesive, fasteners or other suitable means. Because the sensing element 16 is directional, the directions in which the sensing element 16 sends signals are not surrounded by metal, the door 222 does not interfere with the sensing element 16.

As an alternative, the door does not need to be formed of a composite plate, and instead can be formed of a solid material.

Because the sensor 12 senses the absence (door 222 open) or presence (door 222 closed) of the metal of the rear frame 220, the system 10 does not require a secondary component to sense the position of the door 222. This enables the system 10 to be easier to install and easier to maintain than prior art systems. In addition, in the preferred embodiment of the system 10, the status of the sensor 12 can be monitored more readily than in the prior art systems. Because the secondary component is eliminated in the present system, the situation where the door is closed, but the secondary component is missing so that the sensor senses that the door is open is eliminated. Also because the system 10 is self-contained and wireless, installation is greatly reduced from prior art systems in that no routing of a connecting wire is required.

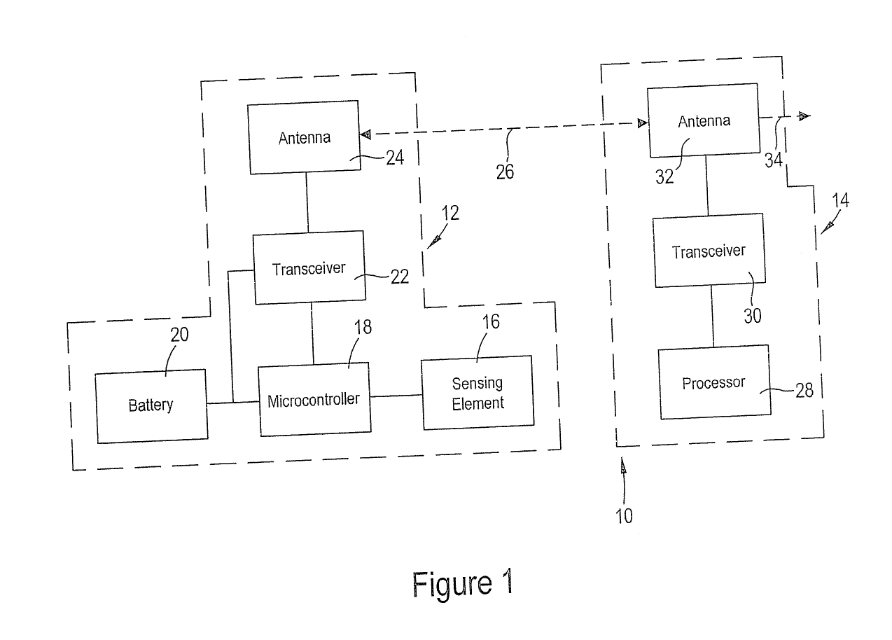

The sensor 12 sends information to, and receives information from, the data concentrator 14 (as indicated by line 26 in FIG. 1). The microcontroller 18 of the sensor 12 may be configured to inform the data concentrator 14 whenever a pre-determined condition has been reached.

The data concentrator 14 includes a processor 28 for processing data and controlling the overall system. The processor 28 is connected to a transceiver 30 which transmits and receives information using an antenna 32. Specifically, the transceiver 30 sends information to, and receives information from, the sensor 12 (as indicated by line 26 in FIG. 1) as well as possibly to and from another, remote site (as indicated by line 34 in FIG. 1). Specifically, the processor 28 may be configured to transmit raw or abstracted data to a management center that provides troubleshooting information, makes resource management decisions (such as preparing parts or labor resources to make a repair), and tracks problems in all or a subset of the commercial vehicles being managed. Preferably, for security reasons, all data that is communicated along lines 26 and 34 in FIG. 1 is encrypted.

Preferably, the processor 28 is configured such that the system 10 not only provides for monitoring, but also for the production of diagnostic and/or prognostic results. Preferably, the data concentrator 14 is configured to request that the sensed data be transmitted by the sensor 12 at pre-determined time periods, said time periods being determined by the data concentrator 14. The microcontroller 18 of the sensor 12 may be configured such that, under certain operational conditions, the sensor 12 alert the data concentrator 14 that a condition exists that might require immediate attention.

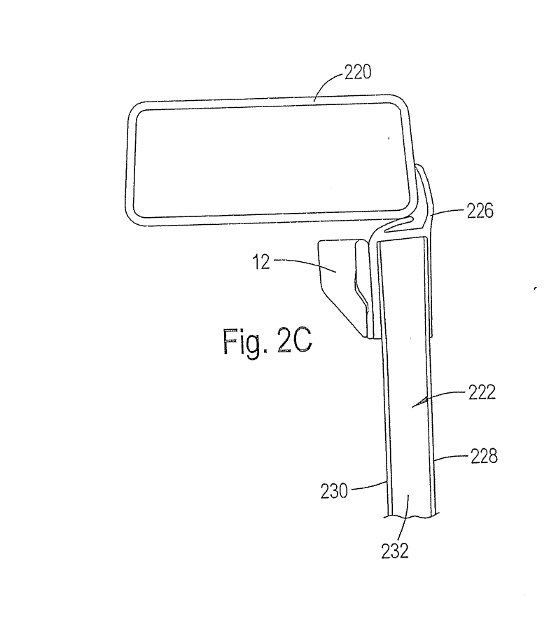

Preferably, the microcontroller 18 of the sensor 12 and the processor 28 of the data concentrator 14 are configured such that the wireless sensor 12 can automatically associate itself with the data concentrator 14, as shown in FIG. 3.

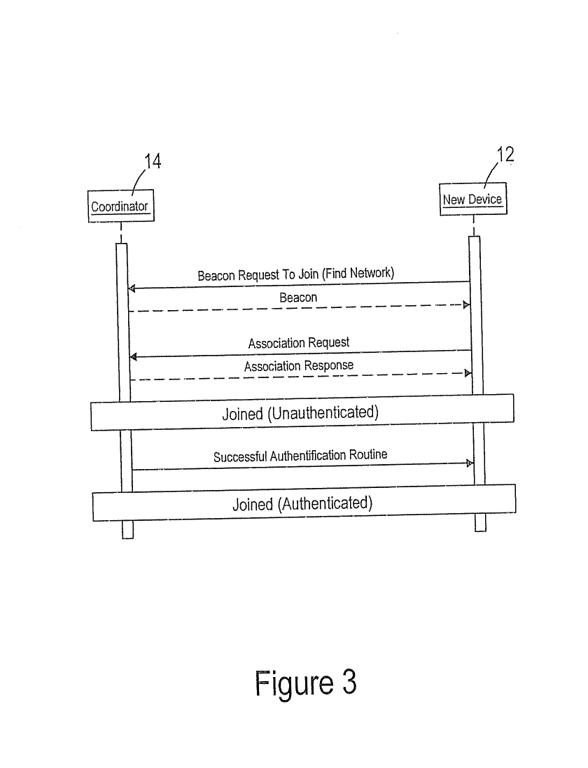

Communication of information from the sensor 12 to the data concentrator 14 shown in FIG. 1 can be performed either as a beacon-type communication or as a non-beacon type communication. Beacon mode is illustrated in FIG. 4 and offers maximum power savings because the data concentrator 14 need not be continuously waiting for communication from the sensor 12. In beacon mode, the sensor 12 effectively “watches out” for the data concentrator's 14 beacon that gets transmitted periodically, locks on and looks for messages addressed to it. If message transmission is complete, the data concentrator 14 dictates a schedule for the next beacon so that the sensor 12 effectively “goes to sleep” with regard to information transmission. The data concentrator 14 may also switch to sleep mode.

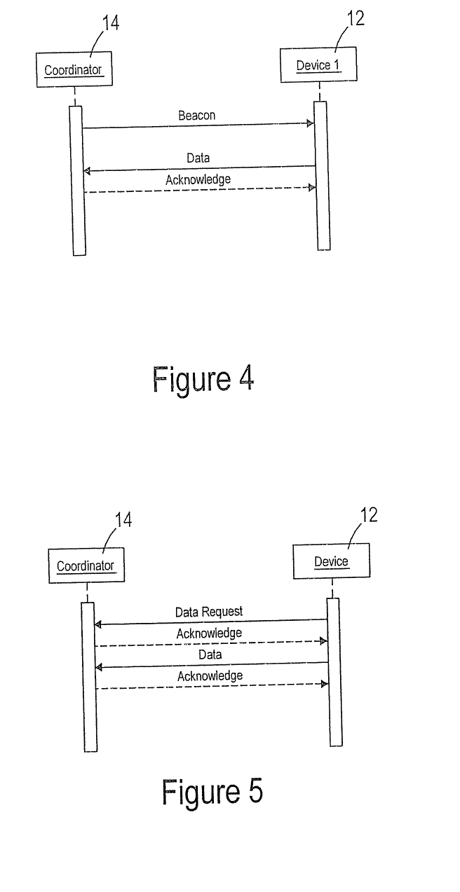

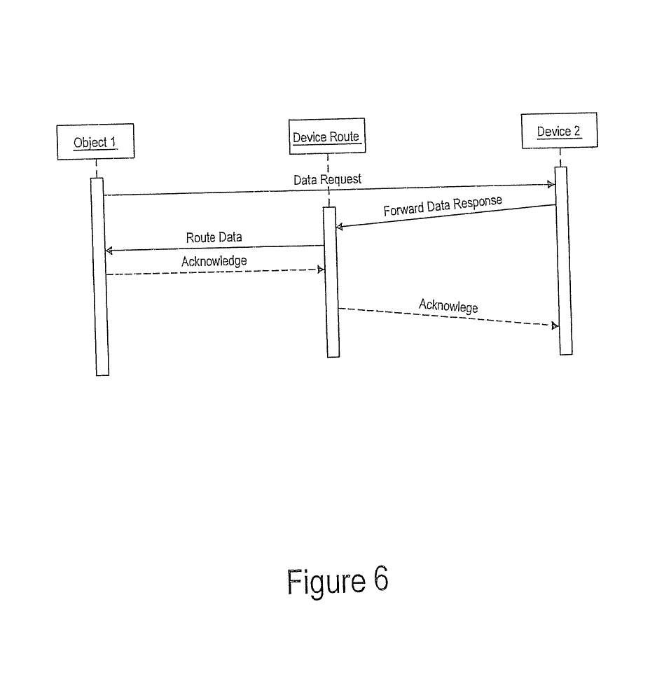

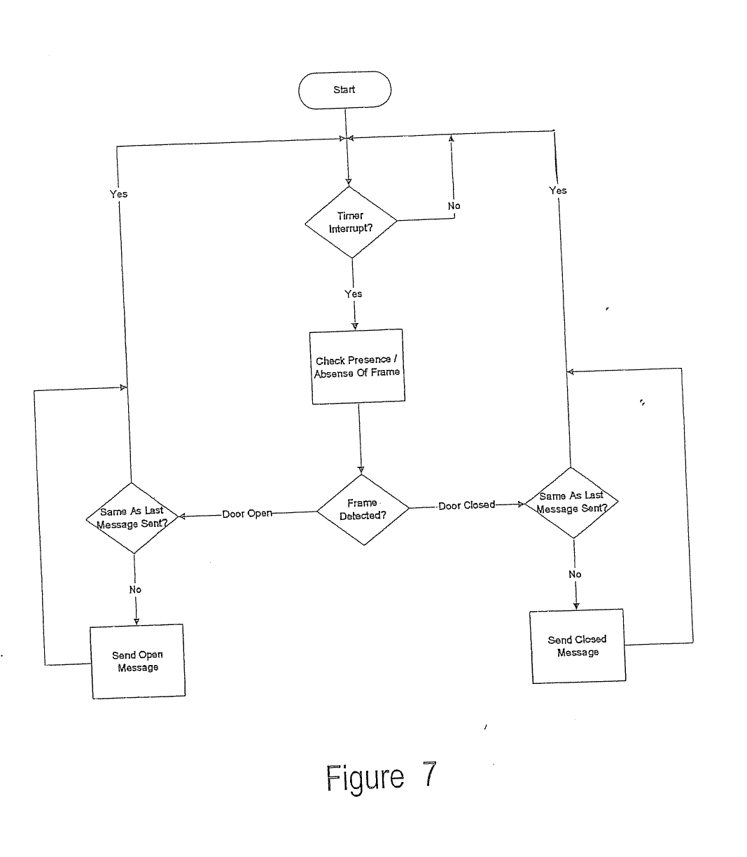

In non-beacon mode, as shown in FIG. 5, the sensor 12 wakes up and confirms its continued presence in the network at random intervals. On detection of activity, the sensor 12 “springs to attention”, as it were, and transmits to the ever-waiting data concentrator's transceiver 30. If the sensor 12 finds the channel busy, the acknowledgment allows for retry until success. As shown in FIG. 6, the sensor 12 can be configured to send information periodically to the data concentrator 14. Additionally, as shown in FIG. 7, the sensor 12 can be configured to relay information through an alternate node that will allow lower transmit power and conserve battery drain.

Other functionality which could be provided may include, but may not be limited to: the sensor 12 and/or data concentrator 14 being able to determine the condition of the battery 20 of the sensor 12. The microcontroller 18 can be configured such that it effectively maintains a gage in memory in order to keep track of how much the sensor 12 has used its battery so the sensor 12 could alert the data concentrator 14 when the battery power reaches a pre-determined level.

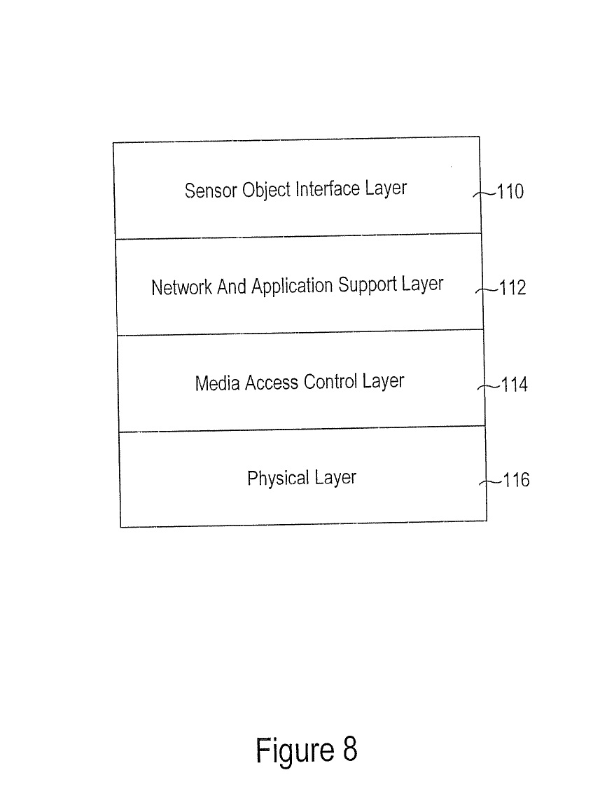

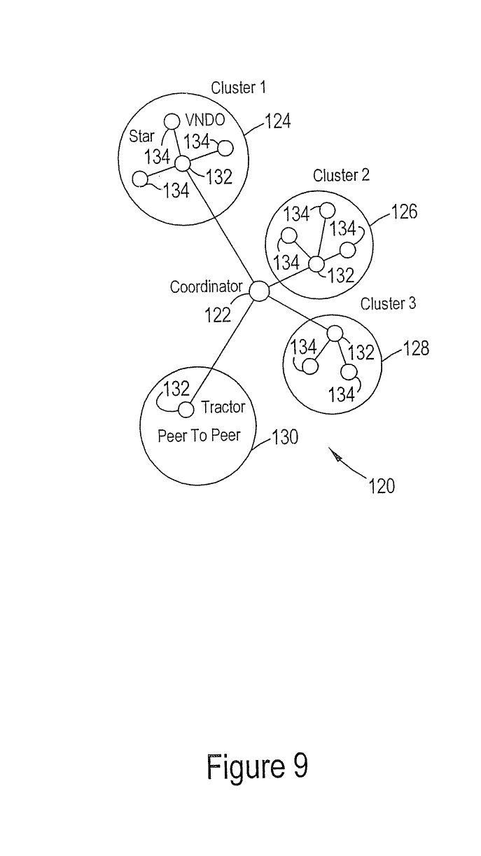

FIG. 8 illustrates the different layers of a wireless mesh network with which the system 10 shown in FIG. 1 can be used. As shown in FIG. 8, the layers include a Sensor Object Interface Layer 110, a Network and Application Support Layer (NWK) 112, a Media Access Control (MAC) Layer 114, and a Physical Layer 116. The NWK layer 112 is configured to permit growth of the network without having to use high power transmitters, and is configured to handle a huge number of nodes. The NWK layer 112 provides the routing and multi-hop capability required to turn MAC level 114 communications into a mesh network. For end devices, this amounts to little more than joining and leaving the network. Routers also have to be able to forward messages, discover neighboring devices and build up a map of the routes to other nodes. In the coordinator (identified with reference numeral 122 in FIG. 9), the NWK layer 112 can start a new network and assign network addresses to new devices when they join the network for the first time. This level in the vehicle network architecture includes the Vehicle Network Device Object (VNDO) (identified in FIG. 9), user-defined application profile(s) and the Application Support (APS) sub-layer, wherein the APS sub-layer's responsibilities include maintenance of tables that enable matching between two devices and communication among them, and also discovery, the aspect that identifies other devices that operate in the operating space of any device.

The responsibility of determining the nature of the device (Coordinator or Full Function Sensor) in the network, commencing and replying to binding requests and ensuring a secure relationship between devices rests with the VNDO. The VNDO is responsible for overall device management, and security keys and policies. One may make calls to the VNDO in order to discover other devices on the network and the services they offer, to manage binding and to specify security and network settings. The user-defined application refers to the end device that conforms architecture (i.e., an application is the software at an end point which achieves what the device is designed to do).

The Physical Layer 116 shown in FIG. 8 is configured to accommodate high levels of integration by using direct sequences to permit simplicity in the analog circuitry and enable cheaper implementations. The physical Layer 116 may be off the shelf hardware such as the Maxstream XBEE module, with appropriate software being used to control the hardware and perform all the tasks of the network as described below.

The Media Access Control (MAC) Layer 114 is configured to permit the use of several topologies without introducing complexity and is meant to work with a large number of devices. The MAC layer 114 provides reliable communications between a node and its immediate neighbors. One of its main tasks, particularly on a shared channel, is to listen for when the channel is clear before transmitting. This is known as Carrier Sense Multiple Access-Collision Avoidance communication, or CSMA-CA. In addition, the MAC layer 114 can be configured to provide beacons and synchronization to improve communications efficiency. The MAC layer 114 also manages packing data into frames prior to transmission, and then unpacking received packets and checking them for errors.

There are three different vehicle network device types that operate on these layers, each of which has an addresses (preferably there is provided an option to enable shorter addresses in order to reduce packet size), and is configured to work in either of two addressing modes—star or peer-to-peer.

FIG. 8 designates the layers associated with the network, meaning the physical (hardware) and interfaced to the MAC that controls the actual performance of the network. FIG. 8 is a description of one “node” while FIG. 9 shows the topology of individual “nodes” and how they are tied together to form the network.

FIG. 9 illustrates a mesh network architecture with which the system shown in FIG. 1 can be used. As shown, the network 120 includes a coordinator 122, and a plurality of clusters 124, 126, 128, 130. Each cluster includes several devices 132, 134 such as sensors, each of which is assigned a unique address. One of the devices (identified with reference numeral 132) of each cluster is configured to receive information from the other devices in the cluster (identified with reference numeral 134), and transmit information to the coordinator 122. The coordinator 122 not only receives information about the network, but is configured to route the information to other networks (as represented by arrow 36 in FIG. 9). As will be described in more detail hereinbelow, the network 120 could be disposed on a tractor-trailer, wherein the devices 132, 134 comprise different sensors, such as pressure sensors, temperature sensors, voltage sensors and switch controls, all of which are located in areas relatively close to each other.

The mesh network architecture provides that the sensors, and the overall network, can effectively self-organize, without the need for human administration. Specifically, the Vehicle Network Device Object (VNDO) (identified in FIG. 9) is originally not associated with any network. At this time it will look for a network with which to join or associate. The coordinator 122 “hears” the request coming from the non-associated VNDO and if it is pertinent to its network will go through the process of binding the VNDO to the network group. Once this association happens, the VNDO learns about all the other VNDO's in the associated network so it can directly talk to them and route information through them. In the same process, the VND can disassociate itself from the network as in the case of a tractor (VND) leaving the trailer (Coordinator) and then associating itself to a new trailer. The VND is an embodiment of both hardware and software to effect the performance of the network. This includes how each element interacts with each other, messages passed, security within the network, etc.

As shown in FIG. 9, there is one, and only one, coordinator (identified with reference numeral 122) in each network to act as the router to other networks, and can be likened to the root of a (network) tree. It is configured to store information about the network. Each cluster includes a full function sensor (FFS) (identified with reference numeral 132) which is configured to function as an intermediary router, transmitting data to the coordinator 122 which it receives from other devices (identified with reference numeral 134). Preferably, each FFS is configured to operate in all topologies and is configured to effectively act as a coordinator for that particular cluster.

The architecture shown in FIG. 9 is configured to provide low power consumption, with battery life ranging from a month to many years. In the vehicle network, longer battery life is achievable by only being used when a requested operation takes place. The architecture also provides high throughput and low latency for low duty-cycle applications, channel access using Carrier Sense Multiple Access with Collision Avoidance (CSMA-CA), addressing space for over 65000 address devices, a typical range of 1100 m, a fully reliable “hand-shaked” data transfer protocol, and different topologies as illustrated in FIG. 9, i.e., star, peer-to-peer, mesh.

The mesh network architecture shown in FIG. 9 has the ability to be able to enhance power saving, thus extending the life of the module based on battery capacity. The architecture is configured to route the information through nodes 132, 134 in the network and also has the ability to reduce the power needed to transmit information. Specifically, natural battery life extension exists as a result of passing information through nodes that are in close proximity to each other.

The sensors 132, 134 in the network are configured such that they are able to go into sleep mode—a mode of operation that draws an extremely low amount of battery current. Each sensor 132, 134 may be configured such that it periodically wakes, performs its intended task and if the situation is normal, returns to its sleep mode. This manner of operation greatly extends the life of the unit by not continually transmitting information, which in a typical vehicle network is the greatest drain on the battery capacity. While in sleep mode, the gateway device 132 requests information from the other devices 134 in the cluster. Acting on this request, the devices 134 wake up, perform the intended task, send the requested information to the gateway device 132, and return to sleep mode.

The vehicle network may be configured to addresses three different data traffic protocols:

1. Data is periodic. The application dictates the rate, and the sensor activates, checks for data and deactivates. The periodic sampling data model is characterized by the acquisition of sensor data from a number of remote sensor nodes and the forwarding of this data to the gateway on a periodic basis. The sampling period depends mainly on how fast the condition or process varies and what intrinsic characteristics need to be captured. This data model is appropriate for applications where certain conditions or processes need to be monitored constantly. There are a couple of important design considerations associated with the periodic sampling data model. Sometimes the dynamics of the monitored condition or process can slow down or speed up; if the sensor node can adapt its sampling rates to the changing dynamics of the condition or process, over-sampling can be minimized and power efficiency of the overall network system can be further improved. Another critical design issue is the phase relation among multiple sensor nodes. If two sensor nodes operate with identical or similar sampling rates, collisions between packets from the two nodes are likely to happen repeatedly. It is essential for sensor nodes to be able to detect this repeated collision and introduce a phase shift between the two transmission sequences in order to avoid further collisions.

2. Data is intermittent (event driven). The application, or other stimulus, determines the rate, as in the case of door sensors. The device needs to connect to the network only when communication is necessitated. This type of data communication enables optimum saving on energy. The event-driven data model sends the sensor data to the gateway based on the happening of a specific event or condition. To support event-driven operations with adequate power efficiency and speed of response, the sensor node must be designed such that its power consumption is minimal in the absence of any triggering event, and the wake-up time is relatively short when the specific event or condition occurs. Many applications require a combination of event-driven data collection and periodic sampling.

3. Data is repetitive (store and forward), and the rate is fixed a priori. Depending on allotted time slots, devices operate for fixed durations. With the store-and-forward data model, the sensor node collects data samples and stores that information locally on the node until the transmission of all captured data is initiated. One example of a store-and-forward application is where the temperature in a freight container is periodically captured and stored; when the shipment is received, the temperature readings from the trip are downloaded and viewed to ensure that the temperature and humidity stayed within the desired range. Instead of immediately transmitting every data unit as it is acquired, aggregating and processing data by remote sensor nodes can potentially improve overall network performance in both power consumption and bandwidth efficiency.

Two different bi-directional data communication models which may be utilized in connection with the present invention are polling and on-demand.

With the polling data model, a request for data is sent from the coordinator via the gateway to the sensor nodes which, in turn, send the data back to the coordinator. Polling requires an initial device discovery process that associates a device address with each physical device in the network. The controller (i.e., coordinator) then polls each wireless device on the network successively, typically by sending a serial query message and retrying as needed to ensure a valid response. Upon receiving the query's answer, the controller performs its pre-programmed command/control actions based on the response data and then polls the next wireless device.

The on-demand data model supports highly mobile nodes in the network where a gateway device is directed to enter a particular network, binds to that network and gathers data, then un-binds from that network. An example of an application using the on-demand data model is a tractor that connects to a trailer and binds the network between that tractor and trailer, which is accomplished by means of a gateway. When the tractor and trailer connect, association takes place and information is exchanged of information both of a data plate and vital sensor data. Now the tractor disconnects the trailer and connects to another trailer which then binds the network between the tractor and new trailer. With this model, one mobile gateway can bind to and un-bind from multiple networks, and multiple mobile gateways can bind to a given network. The on-demand data model is also used when binding takes place from a remote situation such as if a remote terminal was to bind with a trailer to evaluate the state of health of that trailer or if remote access via cellular or satellite interface initiates such a request.

Referring to FIG. 9, the functions of the coordinator 122, which usually remains in the receptive mode, encompass network set-up, beacon transmission, node management, storage of node information and message routing between nodes. The network nodes, however, are meant to save energy (and so ‘sleep’ for long periods) and their functions include searching for network availability, data transfer, checking for pending data and querying for data from the coordinator.

Comparing FIG. 1 to FIG. 9, the data concentrator 14 of FIG. 1 can be used as the coordinator 122 of FIG. 9, and the sensor 12 of FIG. 1 can be used for at least some of the devices 132, 134 of FIG. 9.

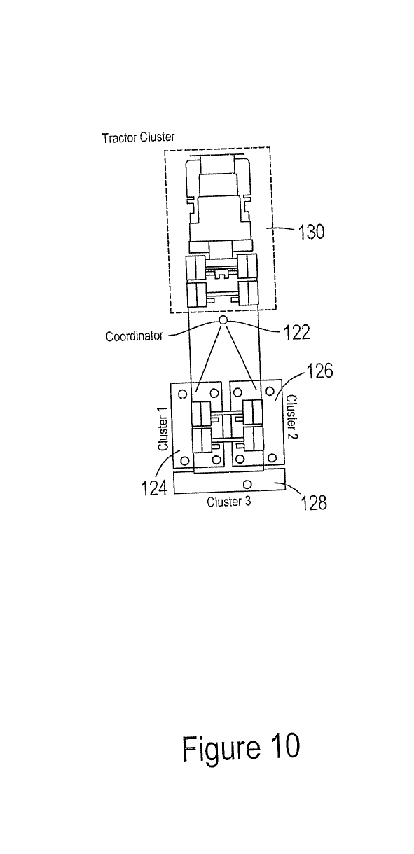

FIG. 10 illustrates an arrangement which is possible on a tractor-trailer. For the sake of simplicity without jeopardizing robustness, this particular architecture defines a quartet frame structure and a super-frame structure used optionally only by the coordinator. The four frame structures are: a beacon frame for the transmission of beacons; a data frame for all data transfers; an acknowledgment frame for successful frame receipt confirmations; and a MAC command frame.

These frame structures and the coordinator's super-frame structure play critical roles in security of data and integrity in transmission. The coordinator lays down the format for the super-frame for sending beacons. The interval is determined a priori and the coordinator thus enables time slots of identical width between beacons so that channel access is contention-less. Within each time slot, access is contention-based. Nonetheless, the coordinator provides as many guaranteed time slots as needed for every beacon interval to ensure better quality.

With the vehicle network designed to enable two-way communications, not only will the driver be able to monitor and keep track of the status of his vehicle, but also feed it to a computer system for data analysis, prognostics, and other management features for the fleets.

While embodiments of the invention are shown and described, it is envisioned that those skilled in the art may devise various modifications without departing from the spirit and scope of the foregoing description.

The invention claimed is:

1. A system for use on a trailer comprising:
a frame;
a door seated within said frame, said door being capable of opening and closing relative to said frame; and
a sensor, said sensor comprising a sensing element mounted on said door and configured to sense said frame, a transceiver, and a microcontroller connected to the transceiver, said sensing element being connected to the microcontroller, wherein the microcontroller is configured to receive information from the sensing element and use the transceiver to wirelessly transmit information regarding a status of the door, said status being related to whether said door is open or closed.

2. A system as defined in claim 1, wherein said sensing element comprises at least one of a hall effect sensor and a reed switch.

3. A system as defined in claim 1, wherein said sensor is mounted along an edge of said door.

4. A system as defined in claim 3, further comprising a door seal attached to said edge of said door, said door seal extending over at least a portion of said sensor.

5. A system as defined in claim 4, wherein said door is formed of skins with a core sandwiched therebetween, said skins defining an opening in which the sensor is disposed.

6. A system as defined in claim 3, further comprising a door seal attached to said edge of said door, said door seal extending over the entire sensor.

7. A system as defined in claim 6, wherein said door is formed of skins with a core sandwiched therebetween, said skins defining an opening in which the sensor is disposed.

8. A system as defined in claim 1, wherein said door is formed of a conductive material, wherein the material of said door surrounding said sensor comprises a non-conductive material.

9. A system as defined in claim 1, wherein said sensor is mounted on an interior surface of said door proximate to an edge thereof.

10. A system as defined in claim 9, further comprising a door seal which extends between at least an upper portion of the sensor and said door.

11. A system as defined in claim 10, wherein a lower portion of said sensor seats against said door and is mounted thereto.

12. A system as defined in claim 11, wherein said door is formed of a formed of skins with a core sandwiched therebetween.

13. A system as defined in claim 1, wherein said sensor further comprises an antenna connected to the transceiver, wherein said transceiver is configured to use the antenna to transmit information.

14. A system as defined in claim 1, wherein said sensor further comprises a battery which powers the microcontroller.

15. A system as defined in claim 1, wherein said system is configured to not only wirelessly transmit information, but is also configured to wirelessly receive information.

16. A system as defined in claim 1, wherein said system is configured to wirelessly receive and implement instructions regarding when to wirelessly transmit information.

17. A system as defined in claim 1, wherein said system is configured to wirelessly communicate in a beacon-type communication, and wherein said system is configured to watch out for a beacon.

18. A system as defined in claim 1, wherein said system is configured to wirelessly communicate in a non-beacon-type communication, and wherein said system is configured to periodically wake up and take at least one measurement.

19. A system as defined in claim 1, wherein said system is configured to associate with a wireless mesh network.

20. A system as defined in claim 1, further comprising a data concentrator comprising a transceiver, a processor connected to the transceiver, wherein the data concentrator is configured to wirelessly receive information from said sensor.

21. A system as defined in claim 20, wherein said sensor is configured to be put into a sleep mode when directed by the data concentrator.

22. A system as defined in claim 21, wherein said sensor is configured to be woken up and made active when directed by the data concentrator.

23. A system comprising:
a frame formed of metal;
a door seated within said frame, said door being capable of opening and closing relative to said frame; and
a sensing element mounted on said door, said sensing element capable of sensing the metal material of said frame for use in determining information as to whether said door is open or closed.

24. A system as defined in claim 23, wherein said sensing element comprises at least one of a hall effect sensor and a reed switch.

25. A system as defined in claim 23, wherein said sensing element mounted along an edge of said door.

26. A system as defined in claim 25, further comprising a door seal attached to said edge of said door, said door seal extending over at least a portion of said sensing element.

27. A system as defined in claim 26, wherein said door is formed of skins with a core sandwiched therebetween, said skins defining an opening in which the sensor is disposed.

28. A system as defined in claim 25, further comprising a door seal attached to said edge of said door, said door seal extending over the entire sensing element.

29. A system as defined in claim 28, wherein said door is formed of skins with a core sandwiched therebetween, said skins defining an opening in which the sensor is disposed.

30. A system as defined in claim 23, wherein said door is formed of a conductive material, wherein the material of said door surrounding said sensing element comprises a non-conductive material.

31. A system as defined in claim 23, wherein said sensing element is mounted on an interior surface of said door proximate to an edge thereof.

32. A system as defined in claim 31, further comprising a door seal which extends between at least an upper portion of the sensing element and said door.

33. A system as defined in claim 32, wherein a lower portion of said sensing element seats against said door and is mounted thereto.

34. A system as defined in claim 32, wherein said door is formed of a formed of skins with a core sandwiched therebetween.

35. A system for use on a trailer comprising:
a frame formed of metal;
a door seated within said flame, said door being capable of opening and closing relative to said frame; and
a sensor, said sensor comprising a sensing element mounted on said door and configured to sense the metal material of said frame, a transceiver, and a microcontroller connected to the transceiver, said sensing element being connected to the microcontroller, wherein the microcontroller is configured to receive information from the sensing element and use the transceiver to wirelessly transmit information regarding a status of the door, said status being related to whether said door is open or closed.

36. A system as defined in claim 35, further comprising a data concentrator comprising a transceiver, a processor connected to the transceiver, wherein the data concentrator is configured to wirelessly receive information from said sensor.
